(19) United States
(12) Patent Application Publication
(10) Pub. No.: US 2020/0059565 A1
(43) Pub. Date: Feb. 20, 2020

(54) IMAGE FORMING APPARATUS AND VIRUS CHECK METHOD

(71) Applicant: KONICA MINOLTA, INC., Tokyo (JP)

(72) Inventors: Masayuki ITO, Tokyo (JP); Kazuhiro TOMIYASU, Toyokawa-shi (JP); Takatsugu KUNO, Toyokawa-shi (JP); Hiroshi SUGIURA, Toyokawa-shi (JP); Shin OHBA, Toyokawa-shi (JP); Akito OTA, Toyokawa-shi (JP)

(73) Assignee: KONICA MINOLTA, INC., Tokyo (JP)

(21) Appl. No.: 16/540,092

(22) Filed: Aug. 14, 2019

(30) Foreign Application Priority Data
Aug. 20, 2018 (JP) 2018-153990

(51) Int. Cl. H04N 1/00; G06F 21/56

(52) U.S. Cl. CPC H04N 1/0088; H04N 1/00915; G06F 2221/034; G06F 21/561; H04N 1/00411

(57) ABSTRACT

An image forming apparatus includes means for storing data, means for dividing data into a plurality of pieces of element data, and means for performing virus check onto each of the plurality of pieces of element data in a designated order.

The entire disclosure of Japanese Patent Application No. 2018-153990 filed on Aug. 20, 2018 is incorporated herein by reference in its entirety.

### BACKGROUND

### Technological Field

The present invention relates to an image forming apparatus and a virus check method performed in an image forming apparatus.

### Description of the Related Art

An image forming apparatus serving as a copying machine, a printer, a facsimile machine, or a combination thereof has conventionally been known. Such an image forming apparatus is connected to another apparatus over a network. Therefore, an image forming apparatus which performs virus check onto received data has been developed.

Japanese Laid-Open Patent Publication No. 2008-77231 discloses a document management server which is communicatively connected to a multi-functional peripheral and performs virus check. When the document management server receives an electronic file from the multi-functional peripheral, it identifies a type of the electronic file. The document management server further performs virus check onto only an electronic file highly likely to be infected with a virus.

### SUMMARY

When a designated job is processed after completion of virus check of data such as a file, start of the job is delayed.

The present disclosure was made in view of the problem above, and an object thereof is to provide an image forming apparatus capable of lessening delay in start of a job due to virus check.

To achieve at least one of the abovementioned objects, according to an aspect of the present invention, an image forming apparatus reflecting one aspect of the present invention comprises storage means for storing data, division means for dividing the data into a plurality of pieces of element data, and first performing means for performing virus check onto each of the plurality of pieces of element data in a designated order.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram showing an internal structure of an image forming apparatus.

FIG. 2 is a block diagram showing one example of a hardware configuration of a main body portion of the image forming apparatus.

FIG. 3 is a diagram for illustrating division of data without a header.

FIG. 4 is a diagram for illustrating division of data with a header.

FIG. 5 is a diagram for illustrating a temporal flow of virus check processing and designated processing.

FIG. 6 is a diagram for illustrating change in order of virus check.

FIG. 7 is a diagram for illustrating change in order when only one page is designated from among a plurality of pages.

FIG. 8 is a diagram for illustrating change in order when two pages are designated from among a plurality of pages.

FIG. 9 is a diagram for illustrating a user interface in designating page data.

FIG. 10 is a diagram for illustrating change in order when two pages are designated from among a plurality of pages.

FIG. 11 is a diagram showing a state that a plurality of pages are divided into a plurality of groups sequentially from a first page every three pages and preview representation of pages by each group is simultaneously provided on a control panel 34.

FIG. 12 is a diagram for illustrating change in order when a page is designated from among a plurality of pages.

FIG. 13 is a diagram for illustrating virus check performed when a flick operation is performed.

FIG. 14 is a diagram for illustrating change in order when a face up function is selected.

FIG. 15 is a diagram for illustrating change in order when a booklet print function is selected.

FIG. 16 is a diagram showing a typical example of a data structure when data is divided and sorted.

FIG. 17 is a functional block diagram for illustrating a functional configuration of the image forming apparatus.

FIG. 18 is a flowchart for illustrating a flow of processing for generating a temporary data queue 402 from document data 401.

FIG. 19 is a flowchart for illustrating a flow of processing for generating a page list from the temporary data queue.

FIG. 20 is a flowchart for illustrating a flow of processing for registering page data from the temporary data queue into a data queue for virus check based on a page list.

FIG. 21 is a flowchart for illustrating details of step S206 in FIG. 19.

FIG. 22 is a flowchart for illustrating a flow of processing in connection with a sub page list.

FIG. 23 is a flowchart for illustrating details of step S209 in FIG. 19.

FIG. 24 is a flowchart for illustrating sort processing based on an operation mode.

### DETAILED DESCRIPTION OF EMBODIMENTS

Hereinafter, one or more embodiments of the present invention will be described with reference to the drawings. However, the scope of the invention is not limited to the disclosed embodiments.

An image forming apparatus in an embodiment will be described below with reference to the drawings. When the number and an amount are mentioned in the embodiment described below, the scope of the present disclosure is not necessarily limited to the number and the amount unless otherwise specified. The same or corresponding elements have the same reference numerals allotted and redundant description may not be repeated.

The drawings are not to scale, and for facilitating understanding of a structure, the drawings may be modified in scale for clarification of the structure. Each embodiment and each modification described below may selectively be combined as appropriate.

Though an image forming apparatus as a color printer will be described below, the image forming apparatus is not limited to the color printer. For example, the image forming apparatus may be a monochrome printer, a FAX, or a multi-functional peripheral (M P) of the monochrome printer, the color printer, and the FAX.

<A. Apparatus Configuration>

[a1. Internal Structure of Image Forming Apparatus 1000]

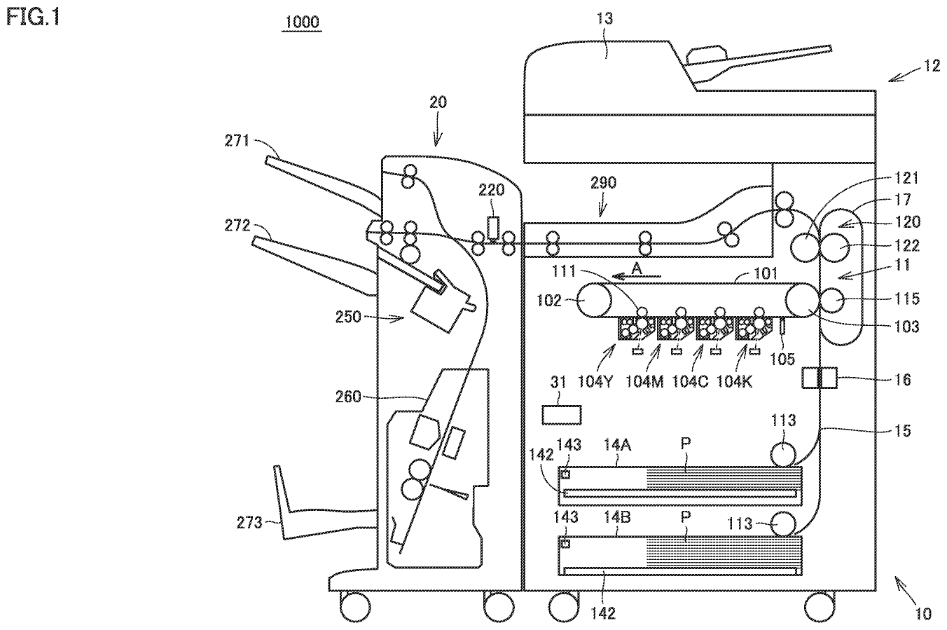

FIG. 1 is a schematic diagram showing an internal structure of an image forming apparatus 1000. Referring to FIG. 1, image forming apparatus 1000 includes a main body portion 10 and a post-processing apparatus 20 as described above.

Main body portion 10 includes an image forming unit 11, a scanner unit 12, an automatic document feed unit 13, paper feed trays 14A and 14B, a transportation path 15, a medium sensor 16, a reverse transportation path 17, and a paper feed roller 113.

Main body portion 10 further includes a controller 31 which controls an operation performed by image forming apparatus 1000. In the present example, main body portion 10 is what is called a tandem color printer. Main body portion 10 forms an image based on print setting.

Automatic document feed unit 13 automatically feeds a document placed on a document table to a position of reading by a document reading portion. Scanner unit 12 scans an image of the document fed by automatic document feed unit 13 and generates scanned data.

Paper feed trays 14A and 14B accommodate paper P. Paper feed roller 113 sends paper P upward along transportation path 15.

Transportation path 15 is used in one-sided printing and double-sided printing. Reverse transportation path 17 is used in double-sided printing.

Image forming unit 11 forms an image on paper P supplied from paper feed trays 14A and 14B based on scanned data generated by scanner unit 12 or print data obtained from a not-shown PC.

Image forming unit 11 includes an intermediate transfer belt 101, registration rollers 102 and 103, a yellow image forming portion 104Y, a magenta image forming portion 104M, a cyan image forming portion 104C, a black image forming portion 104K, an image density sensor 105, a primary transfer apparatus 111, a secondary transfer apparatus 115, and a fixation apparatus 120.

Medium sensor 16 is provided on transportation path 15. Medium sensor 16 performs an automatic paper type sensing function.

Post-processing apparatus 20 further includes a punching apparatus 220, a side stitching portion 250, a saddle stitching portion 260, an ejection tray 271, an ejection tray 272, and a lower ejection tray 273.

[a2. Hardware Configuration of Main Body Portion 10]

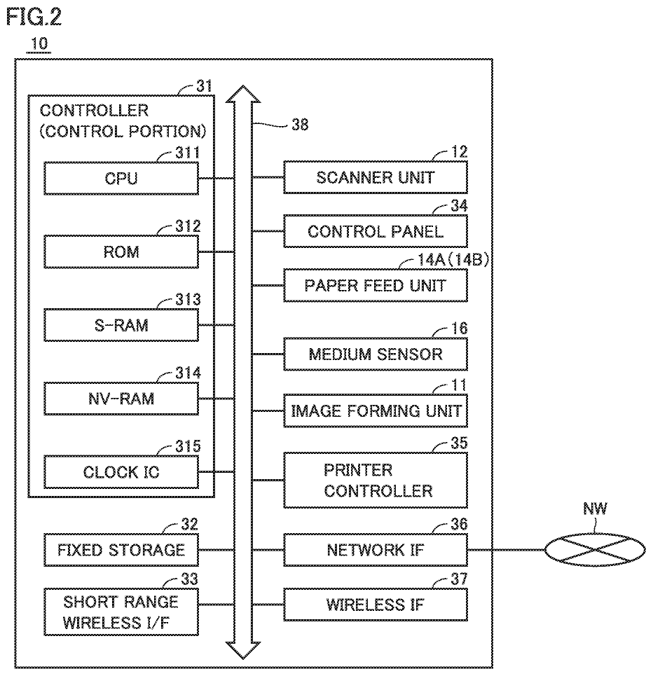

FIG. 2 is a block diagram showing one example of a hardware configuration of main body portion 10 of image forming apparatus 1000.

Referring to FIG. 2, main body portion 10 includes controller 31, a fixed storage 32, a short range wireless interface (IF) 33, scanner unit 12, a control panel 34, paper feed trays 14A and 14B, medium sensor 16, image forming unit 11, a printer controller 35, a network IF 36, and a wireless IF 37. Each of components 11, 12, 14A, 14B, 16, and 32 to 37 is connected to controller 31 through a bus 38.

Controller 31 includes a central processing unit (CPU) 311, a read only memory (ROM) 312 which stores a control program, a static random access memory (S-RAM) 313 for works, a non-volatile RAM (NV-RAM: non-volatile memory) 314 backed up by a battery for storing various types of setting involved with image formation, and a clock integrated circuit (IC) 315. Components 311 to 315 are connected to one another through bus 38.

Control panel 34 includes keys for providing various inputs and a display. Control panel 34 is typically constituted of a touch screen and hardware keys. The touch screen is a device in which a touch panel is laid over a display.

Network IF 36 transmits and receives various types of information to and from an external apparatus such as a PC (not shown) and another image forming apparatus (not shown) connected through a network 39.

Printer controller 35 generates a copy image from print data received from network IF 36. Image forming unit 11 forms the copy image on paper.

Fixed storage 32 is typically implemented by a hard disk apparatus. Fixed storage 32 stores various types of data.

<B. Overview of Processing>

Overview of processing performed in image forming apparatus 1000 will be described.

[b1. Division Processing]

### 1. First Example

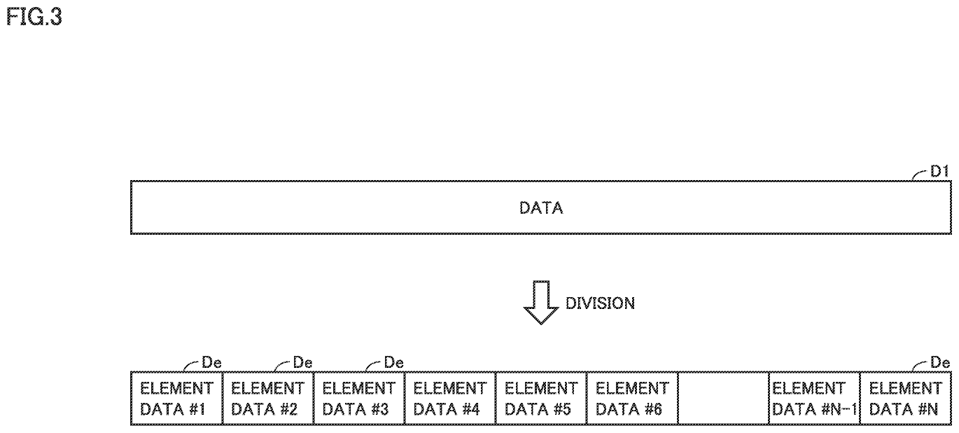

FIG. 3 is a diagram for illustrating division of data without a header.

Referring to FIG. 3, image forming apparatus 1000 stores data D1. Data D1 is typically data received by facsimile. Image forming apparatus 1000 divides data D1 into a plurality of pieces of element data De (element data #1 to # N in an example in FIG. 3). N is a natural number equal to or greater than two.

Image forming apparatus 1000 divides data D1 under a predetermined rule. For example, image forming apparatus 1000 divides data D1 into a prescribed number of sets. Alternatively, image forming apparatus 1000 divides data D1 every prescribed number of pieces of data.

### 2. Second Example

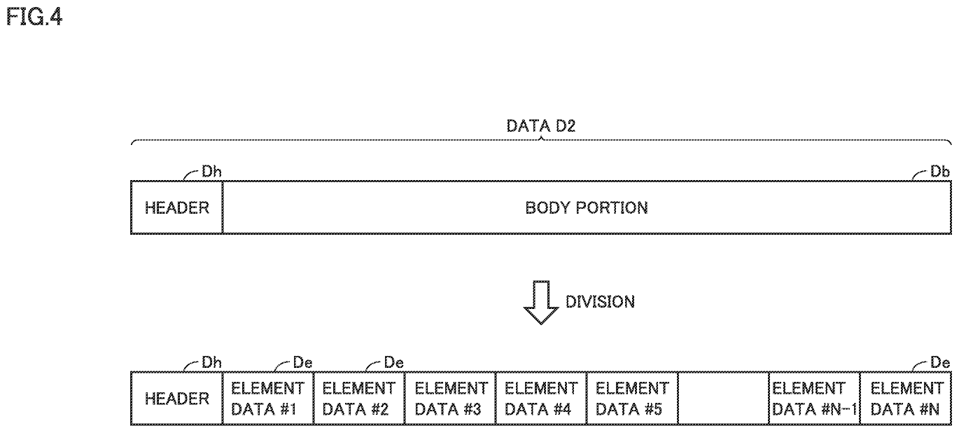

FIG. 4 is a diagram for illustrating division of data with a header.

Referring to FIG. 4, image forming apparatus 1000 stores data D2. Data D2 includes a header Dh and a body portion Db. Image forming apparatus 1000 divides data D2 into a plurality of pieces of element data De. Specifically, image forming apparatus 1000 divides body portion Db into a plurality of pieces of element data De (element data #1 to # N in an example in FIG. 4).

Image forming apparatus 1000 divides body portion Db of data D2 under a predetermined rule. For example, image forming apparatus 1000 divides body portion Db into a prescribed number of sets. Alternatively, image forming apparatus 1000 divides body portion Db every prescribed number of pieces of data. Typically, image forming apparatus 1000 divides body portion Db into a plurality of pieces of element data De based on header information described in header Dh.

[b2. Processing after Division]

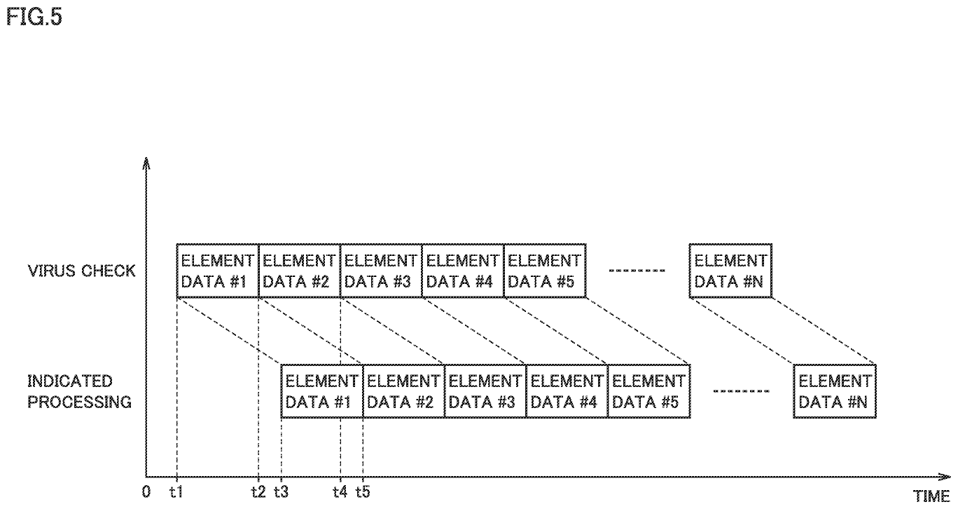

FIG. 5 is a diagram for illustrating a temporal flow of virus check processing and designated processing (processing of a job).

Referring to FIG. 5, image forming apparatus 1000 performs virus check onto element data #1 to # N in a designated order. Since element data #1 to element data # N are arranged in this order in an example in FIG. 5, virus check is performed onto element data sequentially from element data #1.

Specifically, when virus check of element data # i (i being a natural number not smaller than one and not greater than N−1) is completed, image forming apparatus 1000 performs designated processing (a job) onto element data # i of which virus check has been completed, without waiting for completion of virus check of element data # i+1 next in the designated order. For example, when i is set to one and when virus check of element data #1 is completed, image forming apparatus 1000 performs designated processing (a job) onto element data #1 of which virus check has been completed, without waiting for completion of virus check of next element data #2. Examples of designated processing typically include preview representation on control panel 34, print processing, and edition processing.

Thus, image forming apparatus 1000 divides data D1 or D2 into a plurality of pieces of element data De and performs virus check onto each piece of element data De. Therefore, image forming apparatus 1000 can perform prescribed processing onto element data De of which virus check has been completed. In other words, the image forming apparatus can sequentially perform prescribed processing without waiting for completion of virus check of the whole data.

Therefore, image forming apparatus 1000 can lessen delay in start of a job due to virus check as compared with an image forming apparatus configured to perform prescribed processing after waiting for completion of virus check of whole data.

More specifically, in an example of data D2 (FIG. 4) including header Dh, image forming apparatus 1000 initially performs virus check onto header Dh. After image forming apparatus 1000 performs virus check onto header Dh, it divides data (specifically, body portion Db) into a plurality of pieces of element data De. Thereafter, image forming apparatus 1000 performs virus check onto each piece of element data De.

[b3. Order Change Processing]

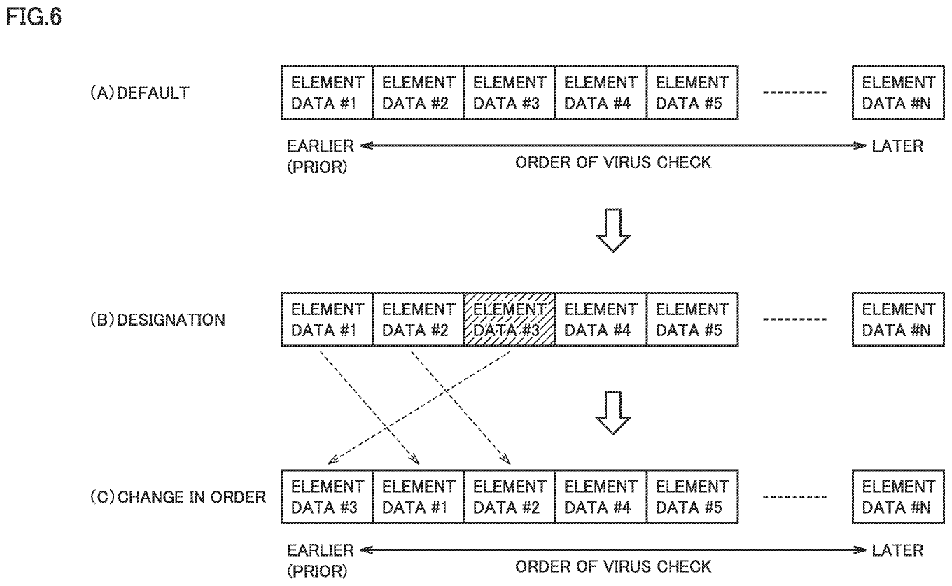

FIG. 6 is a diagram for illustrating change in order of virus check.

Referring to FIG. 6, a state (A) shows default arrangement after division processing. In the state (A), virus check is performed sequentially from element data #1 (from the left in the figure).

A state (B) schematically shows that element data #3 is designated. Designation is typically made by an operation by a user onto control panel 34.

A state (C) shows a state after the state (B). As element data #3 is designated, image forming apparatus 1000 changes an order of virus check onto element data De (element data #1 to # N in an example in FIG. 6) as shown in the state (C).

Specifically, image forming apparatus 1000 performs virus check initially onto designated element data #3. Thereafter, image forming apparatus 1000 performs virus check onto element data De (N−1 pieces of element data #1, #2, #4, #5, . . . , and # N) in the default order except for element data #3.

Thus, image forming apparatus 1000 performs virus check onto designated element data De as being prioritized over other pieces of element data De. Thus, image forming apparatus 1000 can perform prescribed processing (a job) onto designated element data De as being prioritized over prescribed processing onto other pieces of element data De.

<C. Specific Example of Order Change Processing>

Processing for changing an order of virus check from the default order will be described below with reference to a specific example.

An example in which data (for example, data D1 or D2) to be divided is document data (a document file) including a plurality of pages will be described below by way of example. Specifically, an example in which element data De is data of one page (which is also referred to as “page data” below) in document data will be described. Namely, an example in which image forming apparatus 1000 divides document data into data of pages which constitute sentences will be described by way of example. For instance, an example in which a document consisting of ten pages is divided into ten pieces of data of one page will be described.

An example in which “preview representation” is defined as the prescribed processing described above will be described in first, second, and third specific examples below. An example in which “print processing” is defined as the prescribed processing described above will be described in fourth and fifth specific examples.

In the first, second, and third specific examples, it is assumed that page data of a page is designated by designation of the page by an operation to select an icon by a user.

### c1. First Specific Example

(1) Designation of One Page Alone

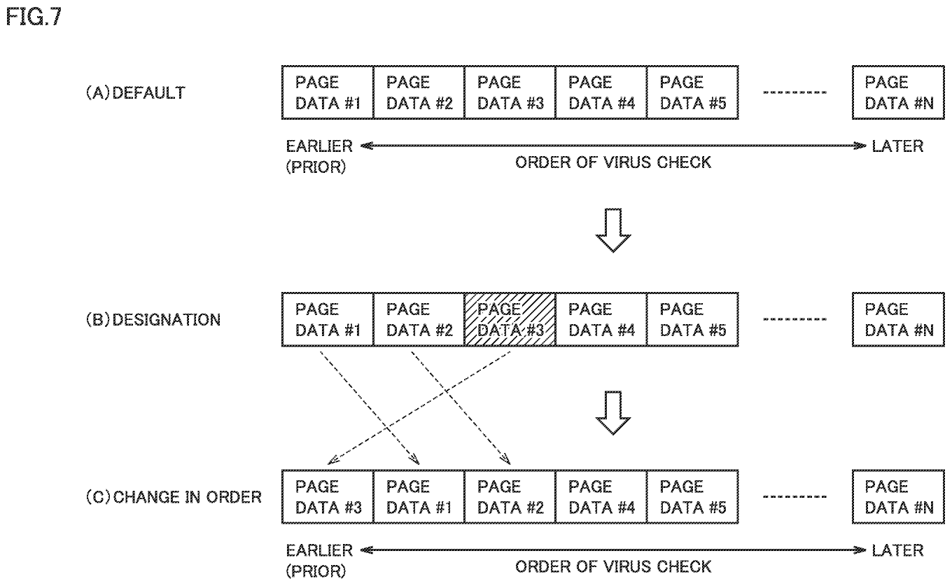

FIG. 7 is a diagram for illustrating change in order when only one page is designated from among a plurality of pages.

Referring to FIG. 7, a state (A) shows default arrangement after division processing. In the state (A), virus check is performed sequentially from page data #1 (from the left in the figure).

A state (B) schematically shows that page data #3 is designated. Designation is typically made by an operation by a user onto control panel 34.

A state (C) shows a state after the state (B). As page data #3 is designated, image forming apparatus 1000 changes an order of virus check of page data #1 to # N as shown in the state (C).

Specifically, image forming apparatus 1000 performs virus check initially onto designated page data #3. Thereafter, image forming apparatus 1000 performs virus check onto page data #1, #2, #4, #5, . . . , and # N in the default order except for page data #3.

Thus, image forming apparatus 1000 performs virus check onto designated page data as being prioritized over other pieces of page data. Image forming apparatus 1000 can thus perform prescribed processing (a job) onto designated page data as being prioritized over prescribed processing onto other pieces of page data.

(2) Designation of a Plurality of Pages

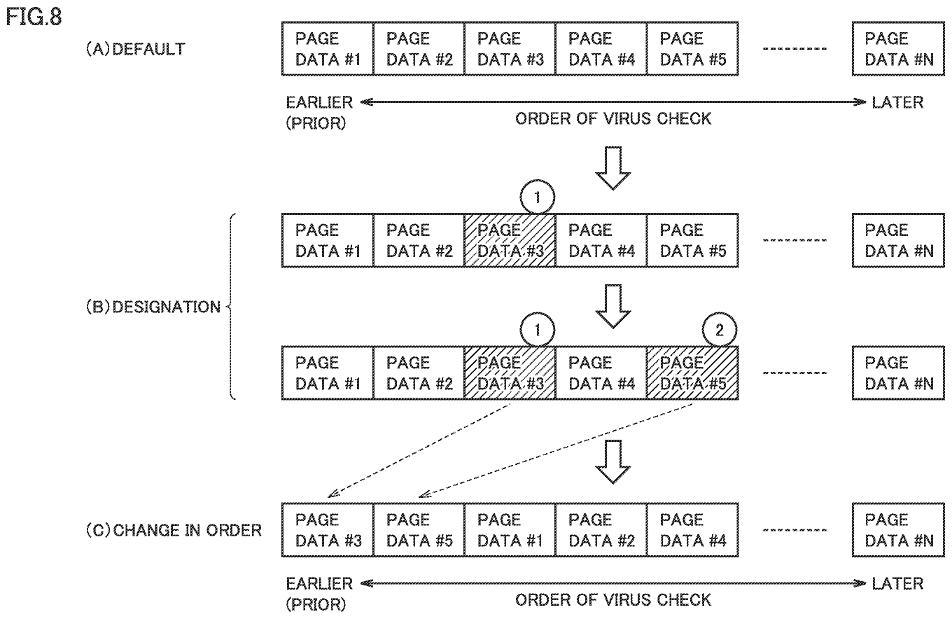

FIG. 8 is a diagram for illustrating change in order when a user designates two pages from among a plurality of pages.

Referring to FIG. 8, a state (A) shows default arrangement after division processing. In the state (A), virus check is performed sequentially from page data #1 (from the left in the figure).

A state (B) schematically shows that page data #3 is designated after the state (A) and page data #5 is further designated after that designation. Such successive designation is typically made by an operation by a user onto control panel 34. A number encircled in the figure represents an order of selection.

A state (C) shows a state after the state (B). When page data #3 and page data #5 are designated, image forming apparatus 1000 changes an order of virus check of page data #1 to # N as shown in the state (C).

Specifically, image forming apparatus 1000 performs virus check initially onto page data #3 designated earlier of two designated pieces of page data #3 and #5. Thereafter, image forming apparatus 1000 performs virus check onto page data #5 designated later. Thereafter, image forming apparatus 1000 performs virus check onto page data #1, #2, #4, #6, . . . , and # N in the default order except for page data #3 and page data #5.

Thus, image forming apparatus 1000 performs virus check onto a plurality of designated pieces of page data as being prioritized over other pieces of page data. Image forming apparatus 1000 can thus perform prescribed processing (a job) onto a plurality of designated pieces of page data as being prioritized over prescribed processing onto other pieces of page data.

(3) Example of User Interface in Designation

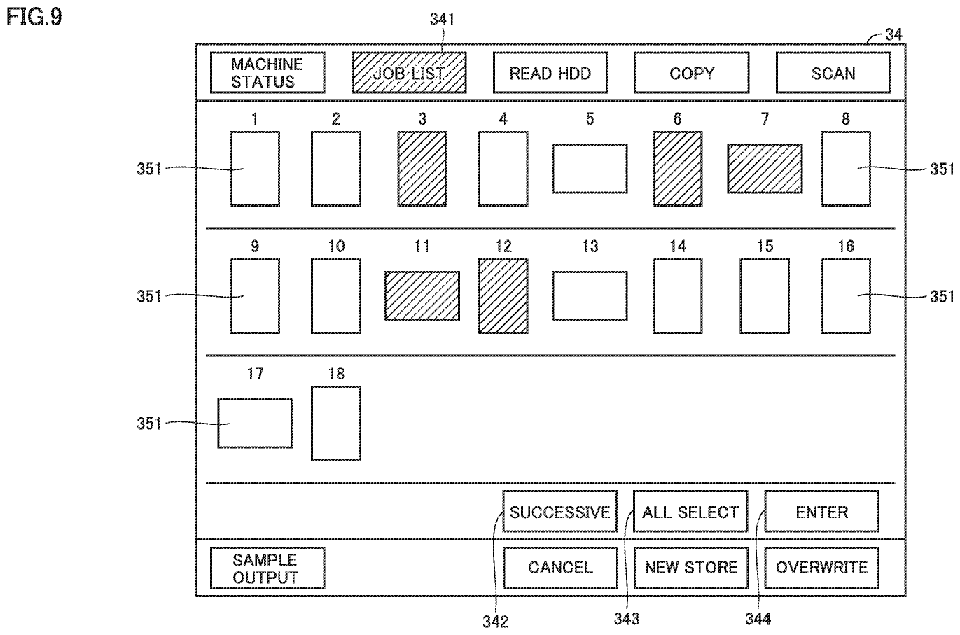

FIG. 9 is a diagram for illustrating a user interface in designating page data.

Referring to FIG. 9, controller 31 of image forming apparatus 1000 has control panel 34 show a plurality of icons (selection buttons) with which selection can be made. In particular, when a user selects an icon 341 labeled as a job list, controller 31 has control panel 34 show icons 351 representing a plurality of pieces of page data included in document data, an icon 342 labeled as successive, an icon 343 labeled as all select, and an icon 344 labeled as enter. Each icon can be selected by a touch operation. Each of icons 351 (which is also referred to as a “page icon 351” below) corresponds to each page of a document.

A state shown in FIG. 9 shows that five page icons 351 representing five pieces of page data #3, #6, #7, #11, and #12 are selected by touch operations onto control panel 34 by a user. As the user selects icon 344 labeled as enter after such touch operations, at least one piece of page data is designated. In performing such successive selection, the user should only select icon 342 labeled as successive before selection of page icon 351.

(4) Summary

Image forming apparatus 1000 accepts designation of at least one page from among a plurality of pages. Typically, designation of a page is accepted by using page icon 351. Image forming apparatus 1000 performs virus check onto page data of the designated page and thereafter performs virus check onto page data of a page other than the designated page from among the plurality of pages.

Alternatively, image forming apparatus 1000 sequentially accepts designation of two or more pages from among a plurality of pages. Image forming apparatus 1000 performs virus check onto page data of the designated pages in the order of acceptance of designation.

### c2. Second Specific Example

In the present specific example, a configuration for changing an order of virus check also of page data of a page which has not been designated will be described.

(1) Prioritization of Designated Page and Page Adjacent Thereto

A configuration for prioritizing virus check also of page data of a page adjacent to a page designated by a user will be described.

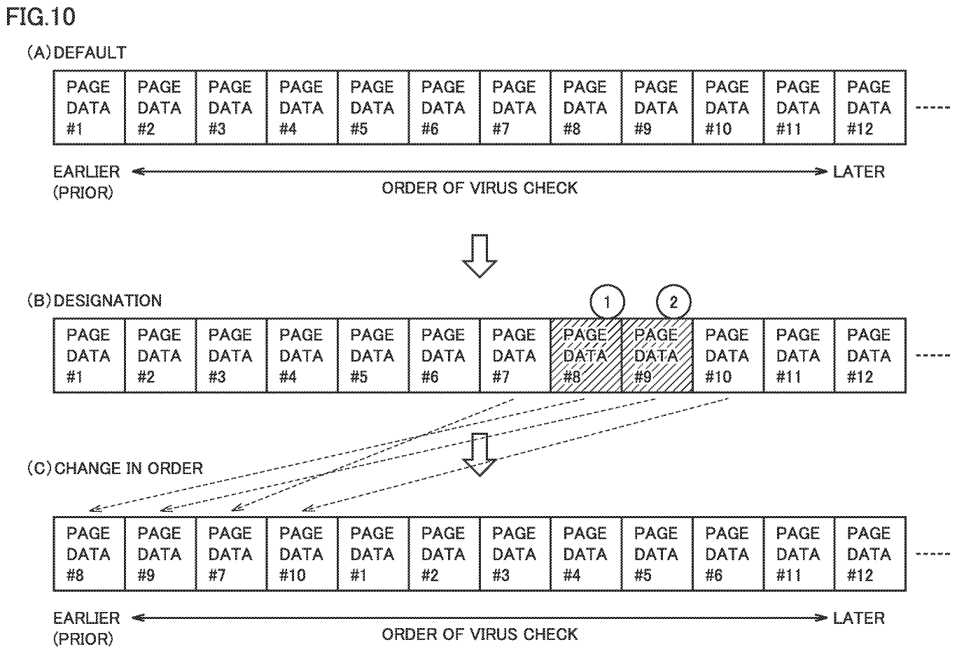

FIG. 10 is a diagram for illustrating change in order when a user designates two pages from among a plurality of pages.

Referring to FIG. 10, a state (A) shows default arrangement after division processing. In the state (A), virus check is performed sequentially from page data #1 (from the left in the figure).

A state (B) schematically shows that page data #8 is designated and page data #9 is further designated after that designation. A number encircled in the figure represents an order of selection as described above. When image forming apparatus 1000 accepts designation of two or more pieces of page data, it determines whether or not all or some of the designated pieces of page data are successive.

A state (C) shows a state after the state (B). When page data #8 and page data #9 are designated, image forming apparatus 1000 changes an order of virus check of page data #1 to # N as shown in the state (C).

Specifically, image forming apparatus 1000 performs virus check initially onto page data #8 designated earlier of two designated pieces of page data #8 and #9. Image forming apparatus 1000 then performs virus check onto page data #9 designated later.

Thereafter, image forming apparatus 1000 performs virus check onto page data #7 adjacent to page data #8 designated earlier. Though page data #7 and page data #9 are adjacent to page data #8, virus check of page data #7 is performed because page data #9 has already been designated.

Image forming apparatus 1000 then performs virus check onto page data #10 adjacent to page data #9 designated later. Though page data #8 and page data #10 are adjacent to page data #9, virus check of page data #10 is performed because page data #8 has already been designated.

Furthermore, image forming apparatus 1000 performs virus check onto page data #1, #2, #3, #4, #5, #6, #11, #12, . . . , and # N in the default order except for four pieces of page data #7 to #10.

Thus, image forming apparatus 1000 performs virus check onto a plurality of designated pieces of page data and onto page data preceding and following the designated page data (immediately preceding page data and page data of the immediately following page) as being prioritized over other pieces of page data. Image forming apparatus 1000 can thus perform prescribed processing (a job) onto a plurality of designated pieces of page data and page data adjacent to the designated page data as being prioritized over prescribed processing on other pieces of page data.

(2) Prioritization of Group Including Designated Pages

Image forming apparatus 1000 has a function to divide a plurality of pages into a plurality of groups sequentially from a first page every predetermined number of pages and to have control panel 34 simultaneously provide preview representation of the predetermined number of pages by the group.

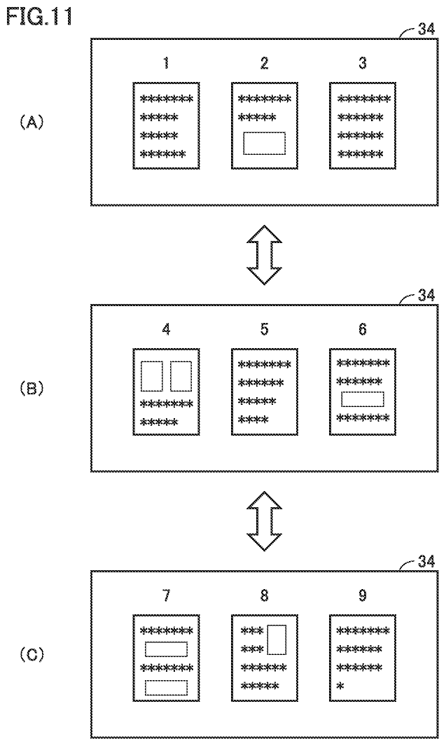

FIG. 11 is a diagram showing a state that a plurality of pages are divided into a plurality of groups sequentially from a first page every three pages and preview representation of pages by the group is simultaneously provided on control panel 34.

Referring to FIG. 11, a state (A) shows that preview representation of page data of three pages from the first page to the third page is provided. A state (B) shows that preview representation of page data of three pages from the fourth page to the sixth page is provided. A state (C) shows that preview representation of page data of three pages from the seventh page to the ninth page is provided.

Image forming apparatus 1000 has representation on control panel 34 make transition from the state (A) to the state (B) based on an operation by a user. Image forming apparatus 1000 has representation on control panel 34 make transition from the state (B) to the state (C) based on an operation by the user. Furthermore, image forming apparatus 1000 has representation on control panel 34 make transition from the state (B) to the state (A) based on an operation by the user.

A configuration for change in order of virus check by image forming apparatus 1000 prior to preview representation when such preview representation is provided will be described below.

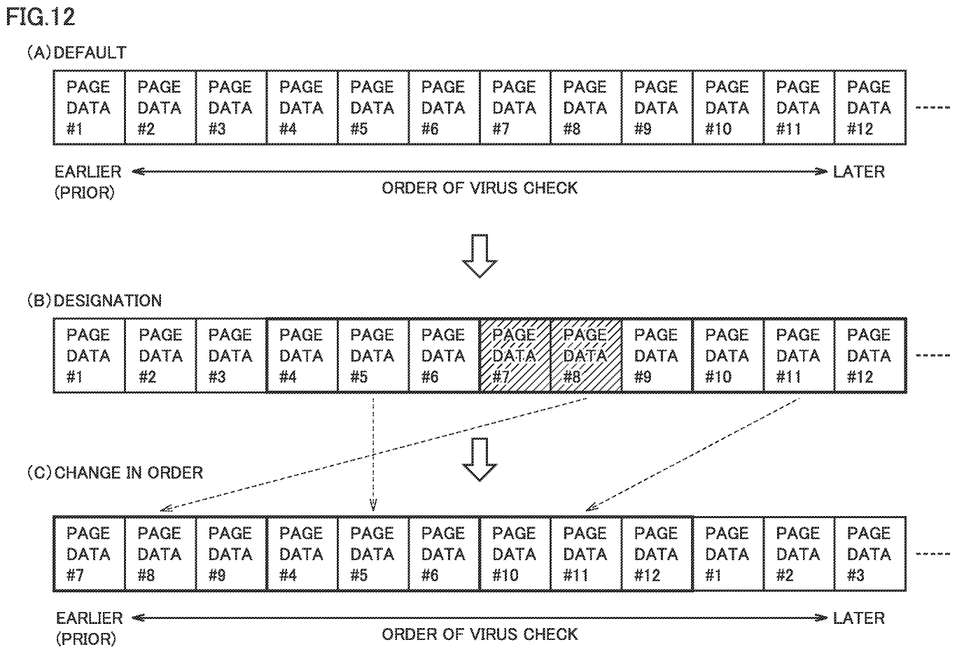

FIG. 12 is a diagram for illustrating change in order when a page is designated from among a plurality of pages.

Referring to FIG. 12, a state (A) shows default arrangement after division processing. A state (B) schematically shows that page data #7 and page data #8 are successively designated after the state (A).

A state (C) shows a state after the state (B). As page data #7 and page data #8 are designated, image forming apparatus 1000 changes an order of virus check of page data #1 to # N as shown in the state (C).

Specifically, image forming apparatus 1000 performs virus check initially onto three pieces of page data #7, #8, and #9 included in a group (which is also referred to as a “third group” below) including two designated pieces of page data #8 and #9. Then, image forming apparatus 1000 performs virus check onto page data #4, #5, and #6 in a preceding group (which is also referred to as a “second group” below) of groups preceding and following the third group. Then, image forming apparatus 1000 performs virus check onto page data #10, #11, and #12 in the following group (which is also referred to as a “fourth group” below). Thereafter, image forming apparatus 1000 performs virus check onto page data in a remaining group (a first group, a fifth group, a sixth group, . . . ) in the ascending order.

In this case, virus check of three pieces of page data #7, #8, and #9 included in the third group including two designated pieces of page data #8 and #9 is prioritized. Therefore, image forming apparatus 1000 can quickly provide preview representation of page data #7, #8, and #9.

As shown in a transition example in FIG. 11, after preview representation of the third group, preview representation of groups preceding and following the third group (the second group and the fourth group) is highly likely to be provided. In this connection, image forming apparatus 1000 performs virus check onto the second group and the fourth group preceding and following the third group, as being prioritized next to the third group. Therefore, image forming apparatus 1000 can quickly provide preview representation of page data included in the second group and the fourth group.

(3) Summary

Image forming apparatus 1000 accepts designation of at least one page from among a plurality of pages. When image forming apparatus 1000 accepts designation of two or more pages, it determines whether or not all or some of the designated pages are successive. When all or some of the designated pages are successive, image forming apparatus 1000 performs virus check initially onto page data of the successive pages. Following virus check of the page data of the successive pages, image forming apparatus 1000 performs virus check onto page data of at least a preceding page and a following page of the successive pages (see FIG. 10).

Image forming apparatus 1000 divides a plurality of pages into a plurality of groups sequentially from the first page every predetermined number of pages and has control panel 34 simultaneously provide preview representation of the predetermined number of pages by the group (see FIG. 11). In performing virus check onto page data of the plurality of pages, image forming apparatus 1000 prioritizes pages included in a group including successive pages and in a preceding group and a following group of the group, and performs virus check onto page data of the prioritized pages (see FIG. 12).

### c3. Third Specific Example

Image forming apparatus 1000 has a function to accept a flick operation on control panel 34. Specifically, image forming apparatus 1000 has control panel 34 show a page icon. More specifically, image forming apparatus 1000 has control panel 34 simultaneously show a predetermined number of page icons. Image forming apparatus 1000 accepts a flick operation in this state. An order of virus check at the time of acceptance of a flick operation will be described below.

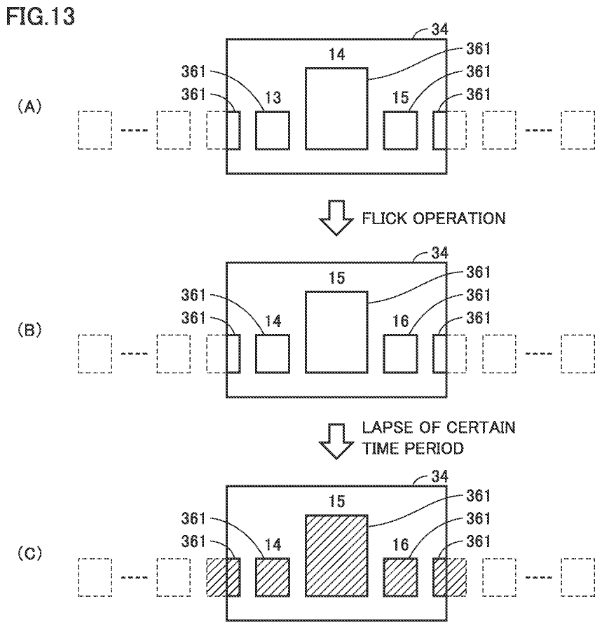

FIG. 13 is a diagram for illustrating virus check performed when a flick operation is performed.

Referring to FIG. 13, a state (A) shows that a page icon 361 representing page data #14 of the fourteenth page is shown as being enlarged in the center of a display screen of control panel 34. In the state (A), page icon 361 representing page data #13 of the thirteenth page and page icon 361 representing page data #15 of the fifteenth page are shown on both sides of page icon 361 representing page data #14.

When control panel 34 accepts a flick operation to move a finger from the right to the left in FIG. 13 in the state (A), the display screen of control panel 34 makes transition from the state (A) to a state (B) by way of example.

The state (B) shows that page icon 361 representing page data #15 of the fifteenth page is shown as being enlarged in the center of the display screen of control panel 34. In the state (B), page icon 361 representing page data #14 of the fourteenth page and page icon 361 representing page data #16 of the sixteenth page are shown on both sides of page icon 361 representing page data #15.

When the state (B) continues for a certain time period or longer, page data associated with the shown icon is designated as shown in a state (C). In the present example, not only page data #15 of the fifteenth page associated with page icon 361 shown in the center of the screen but also page data #14 of the fourteenth page and page data #16 of the sixteenth page are designated. Page data #13 of the thirteenth page and page data #17 of the seventeenth page associated with partly shown page icons 361 are also designated. FIG. 13 schematically shows the designated state by hatching.

With such designation, image forming apparatus 1000 performs virus check onto five pieces of page data #13 to #17 as being prioritized over other pieces of page data. Image forming apparatus 1000 can thus quickly show a preview image of page data corresponding to a page icon shown on the screen of control panel 34 at a position of that page icon.

(Summary)

Image forming apparatus 1000 has control panel 34 simultaneously show a predetermined number of page icons. Image forming apparatus 1000 can have control panel 34 simultaneously provide preview representation of pages as many as the predetermined number. The plurality of pages are associated with page icons different from one another, respectively.

Image forming apparatus 1000 accepts a flick operation onto a page icon. Image forming apparatus 1000 changes a predetermined number of page icons to be shown on control panel 34 based on the flick operation.

Image forming apparatus 1000 determines that a predetermined number of pages associated with the predetermined number of page icons are designated based on representation of the predetermined number of page icons on control panel 34 based on the flick operation.

Specifically, image forming apparatus 1000 determines that a predetermined number of pages are designated on condition that a predetermined number of page icons are shown on control panel 34 for a predetermined time period or longer based on the flick operation.

### c4. Fourth Specific Example

Image forming apparatus 1000 has a face up function (an operation mode) for ejecting paper to a tray with a printed surface facing up. When paper is ejected with the printed surface facing up, a front surface of ejected paper is advantageously seen although an order of successive sheets of paper is reversed. In the present specific example, an order of virus check at the time when a mode of performing the face up function is selected by a user in image forming apparatus 1000 will be described.

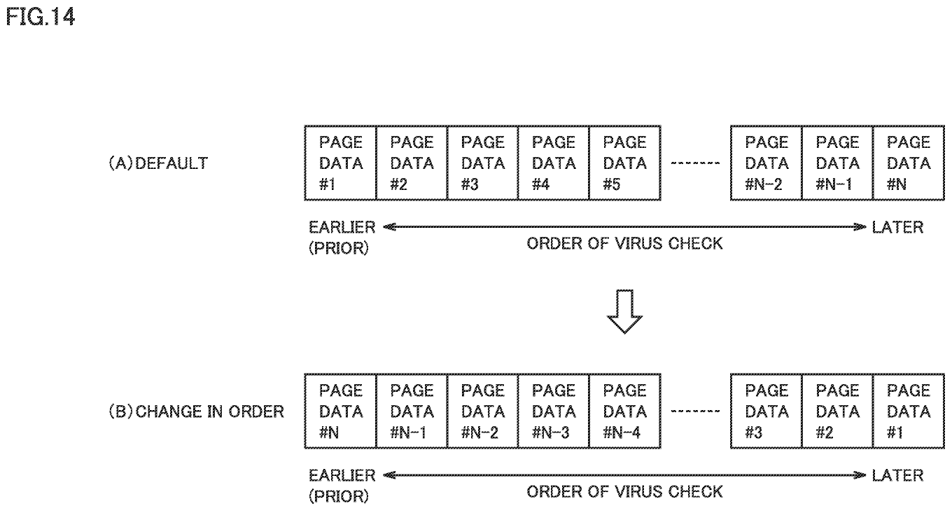

FIG. 14 is a diagram for illustrating change in order when the face up function is selected.

Referring to FIG. 14, a state (A) shows default arrangement after division processing. A state (B) shows a state after change in order. As shown in the state (B), image forming apparatus 1000 performs virus check onto page data of a plurality of pages in a descending order from the last page of the plurality of pages. In other words, image forming apparatus 1000 performs virus check in the order of page data # N, # N−1, # N−2, #3, #2, and #1.

According to such a configuration, virus check can be performed in the order in accordance with the order of printing (descending order) in performing the face up function. Therefore, time required for print processing can be shorter than in virus check in the default order (ascending order).

(Summary)

As set forth above, image forming apparatus 1000 is provided with the operation mode to print pages with the order of the pages being changed from the ascending order to the descending order, and when that operation mode is designated, the image forming apparatus performs virus check onto page data of the plurality of pages in the descending order from the last page of the plurality of pages.

### c5. Fifth Specific Example

Image forming apparatus 1000 is provided with a booklet print function (a book binding function) to make a booklet by making two-sided copies of documents. In the present specific example, an order of virus check at the time when a mode to perform the booklet print function is selected by a user in image forming apparatus 1000 will be described.

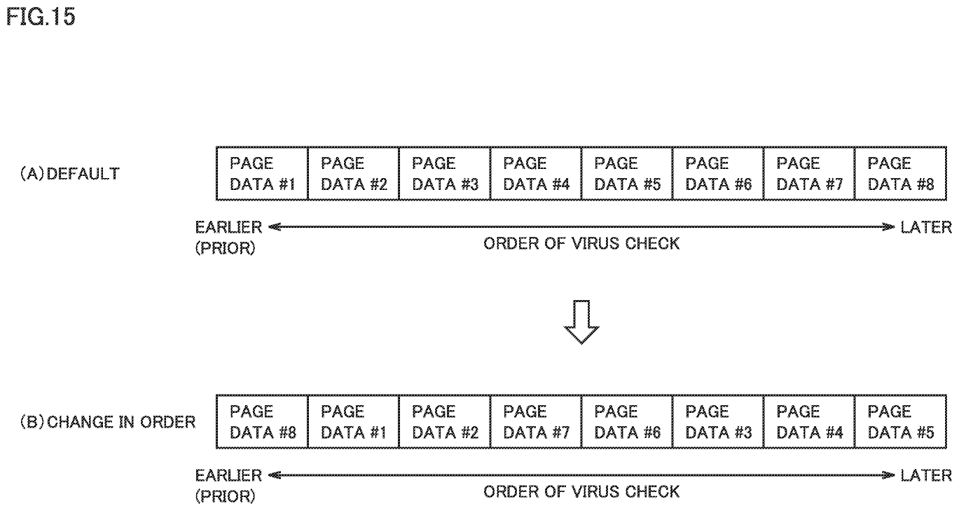

FIG. 15 is a diagram for illustrating change in order when the booklet print function is selected.

Referring to FIG. 15, a state (A) shows default arrangement after division processing. By way of example, default arrangement of eight pieces of page data is shown in making a booklet of eight pages.

A state (B) shows a changed order at the time when the user selects the booklet print function. In this case, image forming apparatus 1000 performs virus check in the order of page data #8, #1, #2, #7, #6, #3, #4, and #5.

According to such a configuration, in performing the booklet print function, virus check can be performed in the order in accordance with the order of printing (sorted order). Therefore, time required for print processing can be shorter than in virus check in the default order (ascending order).

(Summary)

As set forth above, image forming apparatus 1000 is provided with an operation mode to sort the order of pages under a predetermined rule. When that operation mode is designated, image forming apparatus 1000 performs virus check onto page data of a plurality of pages in the sorted order.

<D. Data Structure>

As described above, image forming apparatus 1000 divides document data into a plurality of pieces of page data and sorts divided pieces of page data. A data structure in performing such processing will be described below.

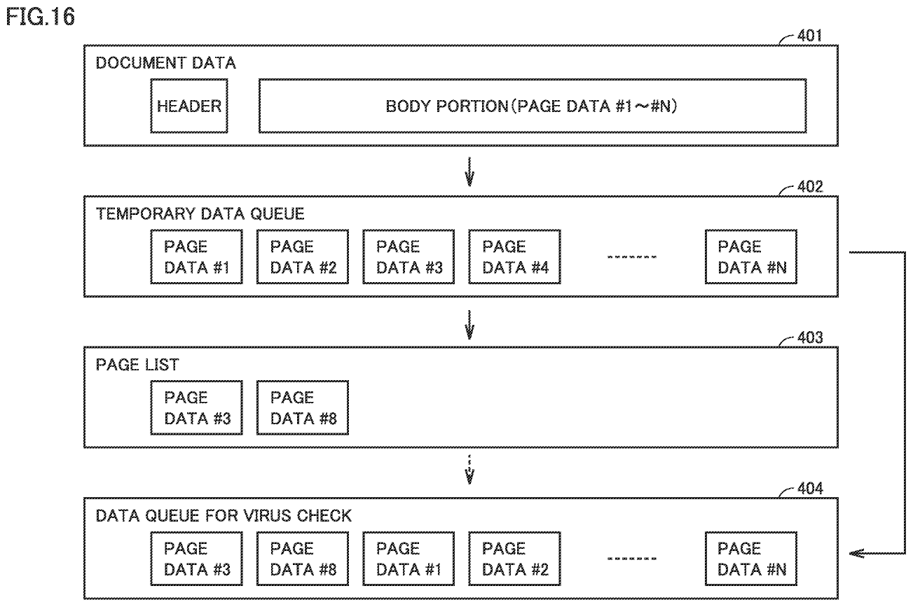

FIG. 16 is a diagram showing a typical example of a data structure when data is divided and sorted.

Referring to FIG. 16, image forming apparatus 1000 includes document data 401, a temporary data queue 402, a page list 403, and a data queue for virus check 404.

The document data includes a header and a body portion. The body portion is constituted of N pieces of page data #1 to # N.

Image forming apparatus 1000 divides the body portion into N pieces of page data and stores page data #1 to # N resulting from division in temporary data queue 402.

For example, when a user designates page data #3 and page data #8 in this order, page information of page data #3 and page information of page data #8 are stored in page list 403 in this order. The page information includes a page number.

When designation of page data ends, data queue for virus check 404 stores page data with the order thereof being changed. In the present example, page data is stored in the order of page data #3, #8, #1, #2, #4, #5, #6, #7, #9, . . . , and # N.

Though details will be described later, page list 403 is typically constituted of a main page list and a sub page list.

<E. Functional Configuration>

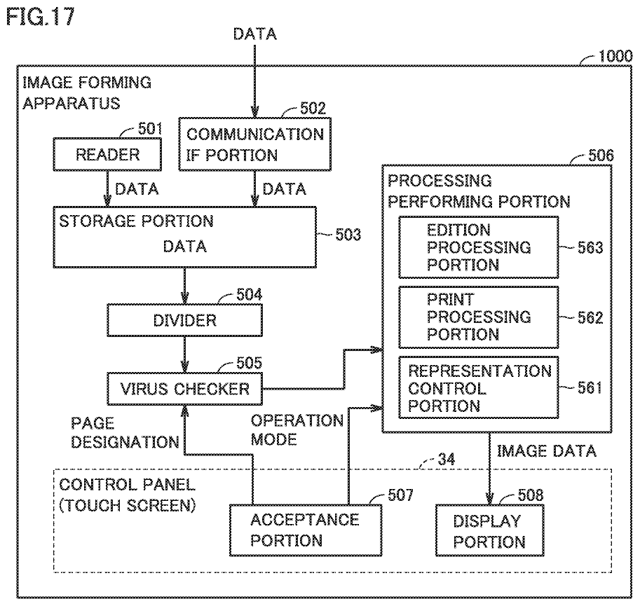

FIG. 17 is a functional block diagram for illustrating a functional configuration of image forming apparatus 1000.

Referring to FIG. 17, image forming apparatus 1000 includes a reader 501, a communication IF portion 502, a storage portion 503, a divider 504, a virus checker 505, a processing performing portion 506, an acceptance portion 507, and a display portion 508. Processing performing portion 506 includes a representation control portion 561, a print processing portion 562, and an edition processing portion 563.

Reader 501 corresponds to scanner unit 12. Reader 501 scans an image of a document fed by automatic document feed unit 13 and generates scanned data.

Communication IF portion 502 receives data from an external apparatus through a network. Alternatively, for example, communication IF portion 502 reads data from a USB memory inserted in a USB port of image forming apparatus 1000.

Data obtained by reader 501 and data received by communication IF portion 502 are stored in storage portion 503.

Divider 504 divides data stored in storage portion 503 into a plurality of pieces of page data. Divider 504 sends the plurality of pieces of page data obtained by division to virus checker 505. Since a specific method of dividing data is described above, description will not be repeated.

Virus checker 505 performs virus check onto each of the plurality of pieces of page data in a designated order. Specifically, the virus checker performs virus check onto page data in the order described based on the first to fifth specific examples.

Acceptance portion 507 accepts an operation by a user. Acceptance portion 507 sends a signal to virus checker 505 based on an operation by the user. For example, acceptance portion 507 accepts designation (selection) of an icon corresponding to page data shown on control panel 34 (display portion 508). In addition, acceptance portion 507 accepts designation of an operation mode. For example, acceptance portion 507 accepts designation of a scanner mode, an edition mode, and a printing mode. In the printing mode, acceptance portion 507 accepts further designation such as designation of the face up function or the booklet print function.

Processing performing portion 506 performs various types of processing. Typically, processing performing portion 506 performs designated processing (processing of a job). In one aspect, processing performing portion 506 performs processing based on an operation by the user.

Representation control portion 561 has display portion 508 show a page icon or a preview image of page data.

Print processing portion 562 controls each component of main body portion 10 to have an image formed on paper P. For example, print processing portion 562 has image forming unit 11 form an image by sending a command to image forming unit 11.

Edition processing portion 563 edits a page designated by the user based on an operation by the user. Specifically, edition processing portion 563 adjusts image quality of the designated page such as an amount of image shift, adjustment of a position of the image, screen processing, or adjustment of a tone curve. Edition processing portion 563 performs sample printing after adjustment of image quality. The user can thus check whether or not adjusted image quality is as expected.

Processing by divider 504, virus checker 505, processing performing portion 506, and acceptance portion 507 will specifically be described below based on the functional block diagram.

(1) When data stored in storage portion 503 includes a header, divider 504 divides the data into a plurality of pieces of page data after virus checker 505 performs virus check onto the header.

(2) In one aspect, when virus check of page data by virus checker 505 is completed, processing performing portion 506 performs designated processing on the page data of which virus check has been completed, without waiting for completion of virus check of page data next in the designated order (see FIG. 5).

(3) In one aspect, acceptance portion 507 accepts designation of at least one page from among a plurality of pages. After virus checker 505 performs virus check onto page data of the designated page, it performs virus check onto page data of a page other than the designated page from among the plurality of pages (see FIG. 7).

(4) In one aspect, acceptance portion 507 sequentially accepts designation of two or more pages from among a plurality of pages. Virus checker 505 performs virus check onto page data of the designated pages in the order of acceptance of designation (see FIG. 8).

(5) In one aspect, acceptance portion 507 accepts designation of at least one page from among a plurality of pages. When acceptance portion 507 accepts designation of two or more pages, virus checker 505 determines whether or not all or some of the designated pages are successive.

When all or some of the designated pages are successive, virus checker 505 performs virus check initially onto page data of the successive pages. Following virus check of the page data of the successive pages, virus checker 505 performs virus check onto page data of at least a preceding page and a following page of the successive pages (see FIG. 10).

(6) In one aspect, representation control portion 561 of processing performing portion 506 performs, as designated processing, division of a plurality of pages into a plurality of groups sequentially from the first page every predetermined number of pages and simultaneous preview representation of the predetermined number of pages by each group on display portion 508.

In virus check of page data of the plurality of pages, virus checker 505 prioritizes pages included in a group including the successive pages and in a preceding group and a following group of the group and performs virus check onto page data of the prioritized pages (see FIG. 12).

(7) Representation control portion 561 of processing performing portion 506 has display portion 508 simultaneously show a predetermined number of page icons. Representation control portion 561 performs, as designated processing, simultaneous preview representation of pages as many as the predetermined number on display portion 508. The plurality of pages are associated with page icons different from one another, respectively.

Acceptance portion 507 further accepts a flick operation onto a page icon. Representation control portion 561 changes the predetermined number of page icons to be shown on display portion 508 based on the flick operation (see the states (A) and (B) in FIG. 13). Acceptance portion 507 determines that the predetermined number of pages associated with the predetermined number of page icons are designated based on representation of the predetermined number of page icons on display portion 508 based on the flick operation.

Specifically, acceptance portion 507 determines that the predetermined number of pages are designated on condition that the predetermined number of page icons are shown on display portion 508 for a predetermined time period or longer based on the flick operation (see the state (C) in FIG. 13).

(8) When the operation mode of the face up function is designated, virus checker 505 performs virus check onto page data of the plurality of pages in the descending order from the last page of the plurality of pages (see FIG. 14).

(9) When the operation mode of the booklet print function is designated, virus checker 505 performs virus check onto page data of the plurality of pages in an order sorted based on a predetermined rule (see FIG. 15).

Divider 504, virus checker 505, and processing performing portion 506 are typically implemented by execution of a program by CPU 311 (FIG. 2). Storage portion 503 may be provided in controller 31 or may be implemented by fixed storage 32.

<F. Control Structure>

A flow of processing performed in image forming apparatus 1000 will now be described. Specifically, processing until page data is registered in data queue for virus check 404 (see FIG. 16) will be described.

Referring again to FIG. 16, processing until registration of page data in data queue for virus check 404 in image forming apparatus 1000 can broadly be categorized into processing (1) to (3) below.

(1) Processing for generating temporary data queue 402 from document data 401

(2) Processing for registration from temporary data queue 402 into page list 403 (including registration in a sub page list when designated pages are successive)

(3) Processing for registration of page data from temporary data queue 402 into data queue for virus check 404 based on page list 403 (order change processing)

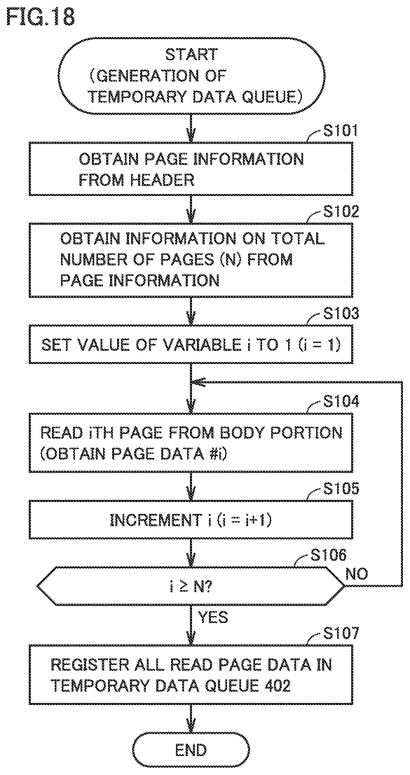

FIG. 18 is a flowchart for illustrating a flow of processing (processing (1)) for generating temporary data queue 402 from document data 401.

Referring to FIG. 18, in step S101, CPU 311 (see FIG. 2 and the like) obtains page information from a header of document data. In step S102, CPU 311 obtains information on a total number of pages (N) of the document data from the obtained page information.

In step S103, CPU 311 sets a value of a predetermined variable i to one. In step S104, CPU 311 reads page data # i of an ith page from a body portion of the document data. In step S105, CPU 311 increments the value of variable i. Specifically, CPU 311 increases the value of i by one.

In step S106, CPU 311 determines whether or not i is equal to or greater than N. When CPU 311 determines that i is equal to or greater than N (YES in step S106), it registers all pieces of read page data #1 to # N in temporary data queue 402 in step S107. When CPU 311 determines that i is smaller than N (NO in step S106), the process proceeds to step S104.

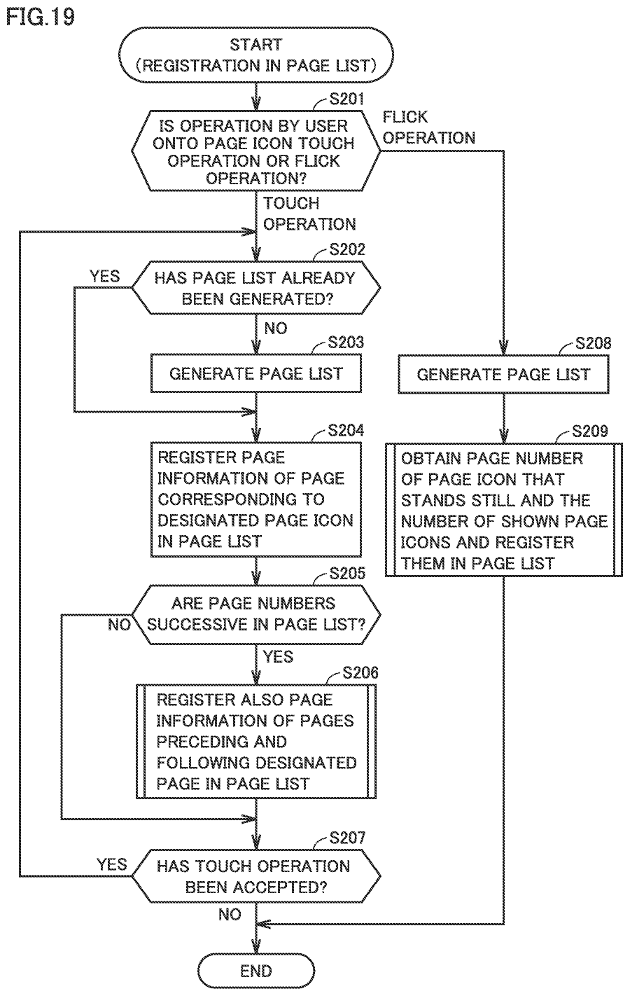

FIG. 19 is a flowchart for illustrating a flow of processing (processing (2)) for generating page list 403 from temporary data queue 402.

In step S201, CPU 311 determines whether an operation by a user onto a page icon (see FIG. 9) is a touch operation or a flick operation. When CPU 311 determines that the operation is the touch operation, the process proceeds to step S202. When CPU 311 determines that the operation is the flick operation, the process proceeds to step S208.

In step S202, CPU 311 determines whether or not page list 403 has already been generated. When CPU 311 determines that page list 403 has not been generated (NO in step S202), it generates page list 403 in step S203. Thereafter, CPU 311 has the process proceed to step S204. When CPU 311 determines that page list 403 has already been generated (YES in step S202), the process proceeds to step S204.

In step S204, CPU 311 registers in page list 403, page information (typically, a page number) of a page corresponding to the page icon designated (selected) by the touch operation.

In step S205, CPU 311 determines whether or not page numbers registered in page list 403 are successive. When CPU 311 determines that the page numbers are successive (YES in step S205), it determines in step S206 that the designated pages are successive and registers also page information of pages preceding and following the designated page in page list 403 (specifically, a sub page list). Thereafter, CPU 311 has the process proceed to step S207. When CPU 311 determines that the page numbers are not successive (NO in step S205), the process proceeds to step S207.

In step S207, CPU 311 determines whether or not it has further accepted a touch operation. When CPU 311 determines that it has accepted a further touch operation (YES in step S207), the process proceeds to step S202. When CPU 311 determines that no further touch operation has been accepted (specifically, an operation by a user to quit selection of page icon 351 is accepted), it quits a series of processing.

In step S208, CPU 311 generates page list 403. In step S209, CPU 311 obtains a page number of designated page icon 361 (located in the center) (see FIG. 13) and the number of shown page icons (five in FIG. 13) and generates page list 403. For example, in FIG. 13, page numbers (page information) of five pages from page 13 to page 17 are registered in page list 403.

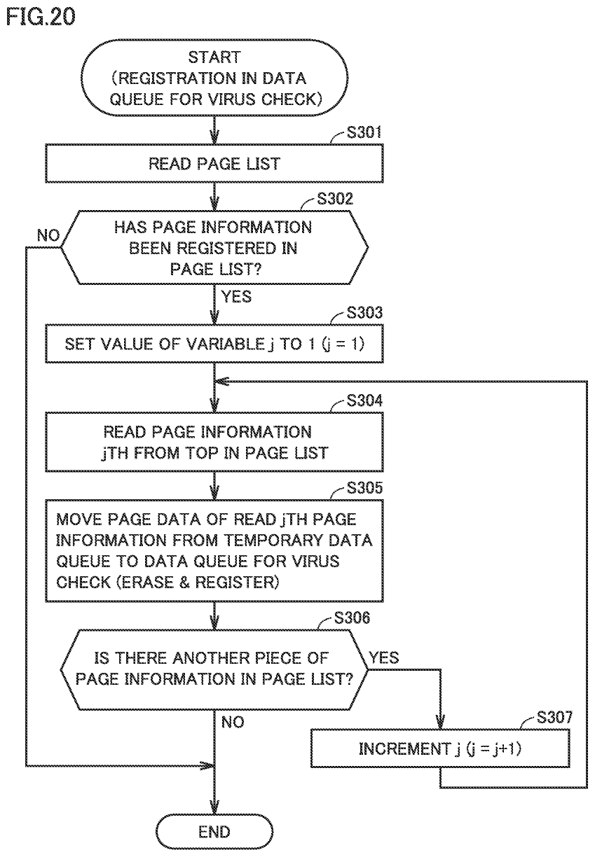

FIG. 20 is a flowchart for illustrating a flow of processing (processing (3)) for registering page data from temporary data queue 402 into data queue for virus check 404 based on page list 403.

Referring to FIG. 20, in step S301, CPU 311 reads page list 403. In step S302, CPU 311 determines whether or not page information has been registered in page list 403. When CPU 311 determines that the page information has been registered (YES in step S302), it sets a value of a predetermined variable j to one in step S303. When CPU 311 determines that the page information has not been registered (NO in step S302), it quits a series of processing.

In step S304, CPU 311 reads page information jth from the top in page list 403. In step S305, CPU 311 moves the page data of read jth page information (typically, a page number) from temporary data queue 402 to data queue for virus check 404. Specifically, after the page data is registered in data queue for virus check 404, the page data is erased from temporary data queue 402.

In step S306, CPU 311 determines whether or not there is another piece of page information in page list 403. When CPU 311 determines that there is another piece of page information (YES in step S306), it increments the value of j in step S307. Thereafter, CPU 311 has the process proceed to step S304. When CPU 311 determines that there is no other page information (NO in step S306), it quits a series of processing.

Details of step S206 in FIG. 19 will now be described. Specifically, processing for registration in a sub page list will be described.

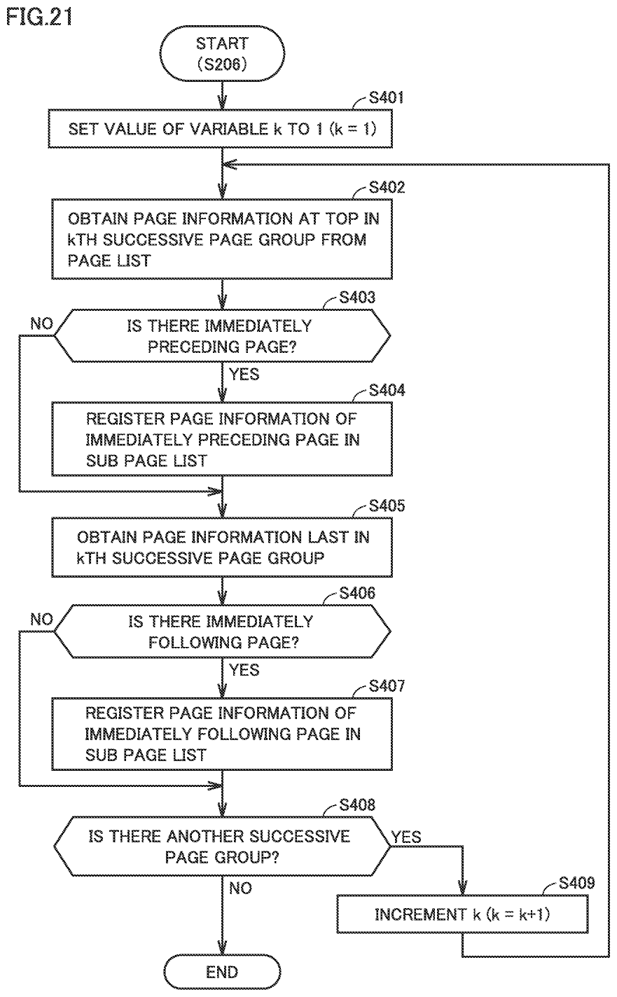

FIG. 21 is a flowchart for illustrating details of step S206 in FIG. 19.

Referring to FIG. 21, in step S401, CPU 311 sets a value of a predetermined variable k to one. In step S402, page information (typically, a page number) at the top in a kth successive page group is obtained from page list 403.

As to definition of the “successive page group,” for example, when page numbers of page 3, page 4, page 8, and page 9 are registered in page list 403 as page information, page 3 and page 4 constitute one successive page group and page 8 and page 9 constitute one successive page group. In this case, there are two successive page groups.

In step S403, CPU 311 determines whether or not there is a page immediately preceding the top page in temporary data queue 402. When CPU 311 determines that there is an immediately preceding page (YES in step S403), it registers page information of the immediately preceding page in the sub page list in step S404. Thereafter, CPU 311 has the process proceed to step S405. When CPU 311 determines that there is no immediately preceding page (NO in step S403), the process proceeds to step S405.

In step S405, CPU 311 obtains page information (typically, a page number) last in the kth successive page group from page list 403. In step S406, CPU 311 determines whether or not there is a page immediately following the last page in temporary data queue 402. When CPU 311 determines that there is an immediately following page (YES in step S406), it registers page information of the immediately following page in the sub page list in step S407. Thereafter, CPU 311 has the process proceed to step S408. When CPU 311 determines that there is no immediately following page (NO in step S406), the process proceeds to step S408.

In step S408, CPU 311 determines whether or not there is another successive page group. When CPU 311 determines that there is another successive page group (YES in step S408), it increments a value of k in step S409. Thereafter, CPU 311 has the process proceed to step S402. When CPU 311 determines that there is no other successive page group (NO in step S408), it quits a series of processing.

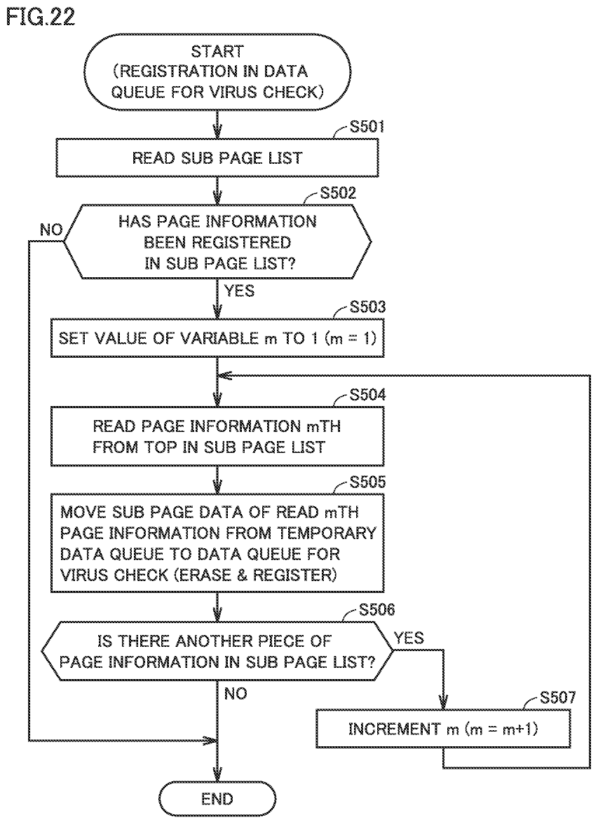

FIG. 22 is a flowchart for illustrating a flow of processing in connection with a sub page list.

Referring to FIG. 22, in step S501, CPU 311 reads a sub page list. In step S502, CPU 311 determines whether or not page information has been registered in the sub page list. When CPU 311 determines that the page information has been registered (YES in step S502), it sets a value of a predetermined variable m to one in step S503.

In step S504, CPU 311 reads page information mth from the top in the sub page list. In step S505, CPU 311 moves page data of read mth page information from temporary data queue 402 to data queue for virus check 404.

In step S506, CPU 311 determines whether or not there is another piece of page information in the sub page list. When CPU 311 determines that there is another piece of page information (YES in step S506), it increments a value of m in step S507. Thereafter, CPU 311 has the process proceed to step S504. When CPU 311 determines that there is no other piece of page information (NO in step S506), it quits a series of processing.

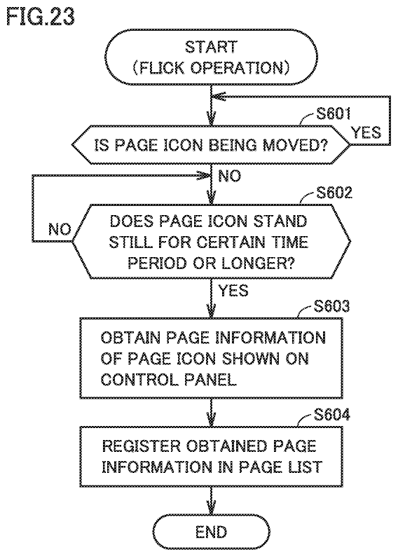

FIG. 23 is a flowchart for illustrating details of step S209 in FIG. 19.

Referring to FIG. 23, in step S601, CPU 311 determines whether or not page icon 361 (see FIG. 13) is being moved. When CPU 311 determines that the page icon is being moved (YES in step S601), it returns the process to step S601. When CPU 311 determines that the page icon is not being moved (NO in step S601), it determines in step S602 whether or not page icon 361 stands still for a certain time period or longer.

When CPU 311 determines that the page icon stands still for the certain time period or longer (YES in step S602), it obtains page information of a page icon shown on control panel 34 in step S603. For example, in the state (C) in FIG. 13, CPU 311 obtains page information (page number) from page 13 to page 17. In step S604, CPU 311 registers the obtained page information in a page list.

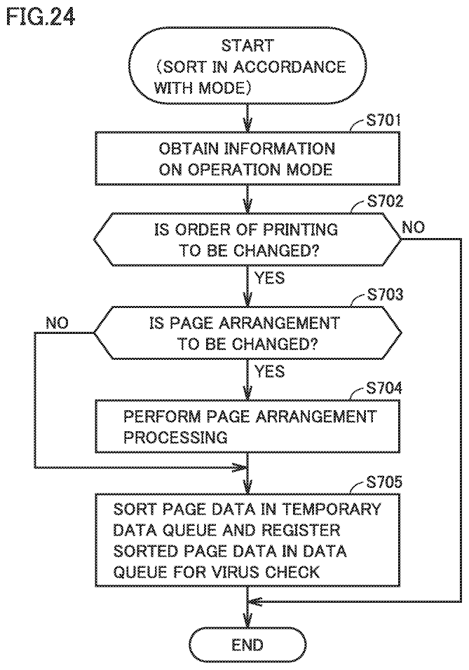

FIG. 24 is a flowchart for illustrating sort processing based on an operation mode.

Referring to FIG. 24, in step S701, CPU 311 obtains information on an operation mode. In step S702, CPU 311 determines whether or not processing for changing an order of printing is to be performed in the obtained operation mode. For example, when the operation mode is set to a mode to perform the face up function or a mode to perform the booklet print function, CPU 311 determines that processing for changing an order of printing is to be performed.

When CPU 311 determines that processing for changing an order of printing is to be performed (YES in step S702), it determines in step S703 whether or not page arrangement is to be changed. For example, when the operation mode is set to the mode to perform the face up function, CPU 311 determines that page arrangement is not to be changed. When the operation mode is set to the mode to perform the booklet print function, CPU 311 determines that page arrangement is to be changed.

When CPU 311 determines that page arrangement is to be changed (YES in step S703), it performs page arrangement processing in step S704. Thereafter, CPU 311 has the process proceed to step S705. When CPU 311 determines that page arrangement is not to be changed (NO in step S703), the process proceeds to step S705.

In step S705, CPU 311 registers page data in temporary data queue 402 into data queue for virus check 404 with the page data being sorted.

(Summary)

According to one aspect of the present disclosure, an image forming apparatus includes storage means for storing data, division means for dividing the data into a plurality of pieces of element data, and first performing means for performing virus check onto each of the plurality of pieces of element data in a designated order.

Preferably, the data includes a header and a body portion. The division means divides the body portion into the plurality of pieces of element data.

Preferably, the first performing means further performs virus check onto the header. The division means divides the data into the plurality of pieces of element data after virus check onto the header is performed.

Preferably, the image forming apparatus further includes second performing means for performing designated processing onto the data. When virus check of the element data is completed, the second performing means performs the designated processing onto element data of which virus check has been completed, without waiting for completion of virus check of element data next in the designated order.

Preferably, the data is document data including a plurality of pages. The element data is page data of one page of the document data.

Preferably, the image forming apparatus further includes acceptance means for accepting designation of at least one page from among the plurality of pages. The first performing means performs, after performing virus check of page data of the designated page, virus check of page data of a page other than the designated page from among the plurality of pages.

Preferably, the acceptance means sequentially accepts designation of two or more pages from among the plurality of pages. The first performing means performs virus check onto page data of the designated pages in an order of acceptance of the designation.

Preferably, the image forming apparatus further includes acceptance means for accepting designation of at least one page from among the plurality of pages. When the acceptance means accepts designation of two or more pages, the first performing means determines whether all or some of the designated pages are successive. When all or some of the designated pages are successive, the first performing means performs virus check initially onto page data of the successive pages. Following the virus check of the page data of the successive pages, the first performing means performs virus check onto page data of at least a preceding page and a following page of the successive pages.

Preferably, the image forming apparatus further includes a touch screen. The second performing means performs, as designated processing, division of the plurality of pages into a plurality of groups sequentially from a first page every predetermined number of pages and simultaneous preview representation of the predetermined number of pages by the group on the touch screen. In virus check of page data of the plurality of pages, the first performing means prioritizes pages included in a group including the successive pages and in a preceding group and a following group of the group and performs virus check onto page data of the prioritized pages.

Preferably, the image forming apparatus further includes a touch screen. The second performing means is representation control means for controlling representation on the touch screen. The representation control means has the touch screen simultaneously show a predetermined number of icons. The representation control means performs, as designated processing, simultaneous preview representation of pages as many as the predetermined number on the touch screen. The plurality of pages are associated with the icons different from one another, respectively. The acceptance means further accepts a flick operation onto the icon. The representation control means changes the predetermined number of icons to be shown on the touch screen based on the flick operation. The acceptance means determines that a predetermined number of pages associated with the predetermined number of icons are designated based on representation of the predetermined number of icons on the touch screen based on the flick operation.

Preferably, the acceptance means determines that the predetermined number of pages are designated on condition that the predetermined number of icons are shown on the touch screen for a predetermined time period or longer based on the flick operation.

Preferably, the image forming apparatus is provided with an operation mode in which pages are printed with an order of the pages being changed from an ascending order to a descending order. When the operation mode is designated, the first performing means performs virus check onto page data of the plurality of pages in the descending order from a last page of the plurality of pages.

Preferably, the image forming apparatus is provided with an operation mode in which an order of the pages is sorted under a predetermined rule. When the operation mode is designated, the first performing means performs virus check onto page data of the plurality of pages in the sorted order.

According to another aspect of the present disclosure, a virus check method includes dividing data stored in a memory into a plurality of pieces of element data and performing virus check onto each of the plurality of pieces of element data in a designated order.

Although embodiments of the present invention have been described and illustrated in detail, the disclosed embodiments are made for the purposes of illustration and example only and not limitation. The scope of the present invention should be interpreted by terms of the appended claims

What is claimed is:

1. An image forming apparatus comprising:
a processor; and
a memory configured to store data,
the processor being configured to
divide the data into a plurality of pieces of element data, and
perform virus check onto each of the plurality of pieces of element data in a designated order.

2. The image forming apparatus according to claim 1, wherein
the data includes a header and a body portion, and
the processor is configured to divide the body portion into the plurality of pieces of element data.

3. The image forming apparatus according to claim 2, wherein
the processor is configured to
further perform the virus check onto the header, and
divide the data into the plurality of pieces of element data after performing virus check onto the header.

4. The image forming apparatus according to claim 1, wherein
the processor is configured to
perform designated processing onto the data, and
perform, when the virus check of the element data is completed, the designated processing onto element data of which virus check has been completed, without waiting for completion of the virus check of element data next in the designated order.

5. The image forming apparatus according to claim 4, wherein
the data is document data including a plurality of pages, and
the element data is page data of one page of the document data.

6. The image forming apparatus according to claim 5, wherein
the processor is configured to
accept designation of at least one page from among the plurality of pages, and
perform, after the processor performs the virus check onto page data of the designated page, the virus check onto page data of a page other than the designated page from among the plurality of pages.

7. The image forming apparatus according to claim 6, wherein
the processor is configured to
sequentially accept designation of two or more pages from among the plurality of pages, and
perform the virus check onto page data of the designated pages in an order of acceptance of the designation.

8. The image forming apparatus according to claim 5, wherein
the processor is configured to
accept designation of at least one page from among the plurality of pages,
determine, when designation of two or more pages is accepted, whether all or some of the designated pages are successive,
perform, when all or some of the designated pages are successive, the virus check initially onto page data of the successive pages, and
perform, following the virus check of the page data of the successive pages, the virus check onto page data of at least a preceding page and a following page of the successive pages.

9. The image forming apparatus according to claim 8, further comprising a touch screen, wherein
the processor is configured to
perform, as the designated processing, division of the plurality of pages sequentially from a first page into a plurality of groups every predetermined number of pages and simultaneous preview representation of the predetermined number of pages by the group on the touch screen, and
prioritize, in performing the virus check onto page data of the plurality of pages, pages included in a group including the successive pages and a preceding group and a following group of the group, and perform virus check onto page data of the prioritized pages.

10. The image forming apparatus according to claim 6, further comprising a touch screen, wherein
the processor is configured to
have the touch screen simultaneously show a predetermined number of icons, and
perform, as the designated processing, simultaneous preview representation of pages as many as the predetermined number on the touch screen,
the plurality of pages are associated with the icons different from one another, respectively, and
the processor is configured to
further accept a flick operation onto the icon,
change the predetermined number of icons to be shown on the touch screen based on the flick operation, and
determine that a predetermined number of pages associated with the predetermined number of icons are designated based on representation of the predetermined number of icons on the touch screen based on the flick operation.

11. The image forming apparatus according to claim 10, wherein
the processor is configured to determine that the predetermined number of pages are designated on condition that the predetermined number of icons are shown on the touch screen for a predetermined time period or longer based on the flick operation.

12. The image forming apparatus according to claim 5, being provided with an operation mode in which pages are printed with an order of the pages being changed from an ascending order to a descending order, wherein
when the operation mode is designated, the processor is configured to perform the virus check onto each of pieces of page data of the plurality of pages in the descending order from a last page of the plurality of pages.

13. The image forming apparatus according to claim 5, being provided with an operation mode in which an order of the pages is sorted under a predetermined rule, wherein
when the operation mode is designated, the processor is configured to perform the virus check onto page data of the plurality of pages in the sorted order.

14. A virus check method comprising:
dividing data stored in a memory into a plurality of pieces of element data; and
performing virus check onto each of the plurality of pieces of element data in a designated order.

15. The virus check method according to claim 14, wherein
the data includes a header and a body portion, and
in the dividing data, the body portion is divided into the plurality of pieces of element data.

16. The virus check method according to claim 15, wherein
in the performing virus check, the virus check onto the header is further performed, and
in the dividing data, the data is divided into the plurality of pieces of element data after the virus check onto the header is performed.

17. The virus check method according to claim 14, further comprising performing, when the virus check of the element data is completed, designated processing onto element data of which virus check has been completed, without waiting for completion of the virus check of element data next in the designated order.

18. The virus check method according to claim 17, wherein
the data is document data including a plurality of pages, and
the element data is page data of one page of the document data.

19. The virus check method according to claim 18, further comprising accepting designation of at least one page from among the plurality of pages, and
in the performing virus check, performing, after performing the virus check onto page data of the designated page, the virus check of page data of a page other than the designated page from among the plurality of pages.

20. The virus check method according to claim 19, wherein
in the accepting designation, designation of two or more pages from among the plurality of pages is sequentially accepted, and
in the performing virus check, the virus check is performed onto page data of the designated pages in an order of acceptance of the designation.
